(19) United States
(12) Patent Application Publication
(10) Pub. No.: US 2025/0157221 A1
(43) Pub. Date: May 15, 2025

(54) AUTONOMOUS MAINTENANCE VISUAL INSPECTION

(71) Applicant: HITACHI VANTARA LLC, Santa Clara, CA (US)

(72) Inventors: Fnu AIN-UL-AISHA, Framingham, MA (US); Mohan WANG, Issaquah, WA (US); Mauro DAMO, Windermere, FL (US); Wei LIN, Plainsboro, NJ (US)

(21) Appl. No.: 18/838,387

(22) PCT Filed: Feb. 14, 2022
(86) PCT No.: PCT/US2022/016351

§ 371 Date: Aug. 14, 2024

(51) Int. Cl. G06V 20/52; G06N 20/00; G06T 7/00; G06V 10/44; G06V 10/764; G06V 20/17; G06V 20/70

(52) U.S. Cl. CPC G06V 20/52; G06N 20/00; G06T 7/0002; G06V 10/44; G06V 10/764; G06V 20/17; G06V 20/70; G06T 2207/30168; G06V 2201/07

(57) ABSTRACT

Example implementations described herein involve systems and methods for autonomous visual inspection, which may include receiving images autonomously captured via at least one image capturing device; identifying at least one object from the images autonomously based on a set of inference data from a machine learning (ML) module; identifying at least one feature of the at least one object autonomously based on the set of inference data; and initiating an alert autonomously if the at least one feature meets a defined condition or a threshold. In some aspects, the example implementations may further include annotating the at least one object or the at least one feature identified on the images via the ML module; reviewing and reannotating one or more images from the images based on a set of inferenced images; and retraining the ML module based on the one or more images.

### BACKGROUND

### Field

The present disclosure is generally related to an object inspection, and more specifically, to an autonomous maintenance visual inspection of object based on a machine learning (ML) model.

### Related Art

Many manufacturers and service providers are required to inspect their product, equipments, and/or warehouses (collectively as “objects”) from time to time to ensure that their objects are not damaged or in a defective condition (which may collectively referred to as “feature(s),” e.g., ensure that objects include or exclude certain features). For example, an automaker may periodically inspect their automobile production lines to ensure that the equipments for assembling the automobiles are functioning properly, and/or inspect assembled automobiles at their warehouses once in a while to ensure that the stored automobiles are in a good condition. In another example, a power supply company may periodically inspect their equipments, such as powerlines, power generators, and/or electric power towers from time to time to ensure that the equipments are not defective or in a hazardous condition (e.g., corrosion, mechanical wear and fatigue, timber rot, etc.). As such, object inspection (or object feature detection) may be an integral part of a maintenance pipeline in many industries and a correct and timely object inspection may be important for scheduling and allocating maintenance resources.

Related art implementations for inspecting objects (or for object inspections) typically involve a human intervention. For example, a common process of object inspections may be done by a subject matter expert (SME) visually inspecting the objects. When several objects are connected in tandem, an SME may be required to walk across the objects to inspect them, which can be time consuming and laborious. In some scenarios, for objects that are at hard-to-reach and/or unsafe areas, an SME may inspect these objects with the assistance of camera images and/or videos. For example, an SME may use a drone to take real time pictures of the objects, such as objects that are placed at hard-to-reach locations. Then, the SME may inspect the images or videos of the objects collected by the drone in real time or later.

### SUMMARY

While visual inspection of objects by an SME or a group of SMEs may be a common method employed by several industries, either in person or via images and videos, the process of the visual inspection may still be laborious, hazardous, costly, and/or time consuming based on the objects' geo-physical locations.

For example, visual inspections of objects may be laborious and hazardous for energy industries, where a power company's power supply networks may compose of several smaller convoluted regional networks that are geographically distributed ranging from rural to urban areas and run for miles in length. Given the remote locations and height placement of the objects (e.g., the electric towers), a field object inspection may be considered very dangerous for an SME. For example, an SME not only has to be extremely careful while climbing energized electric towers but also must be aware of the territorial behavior of the birds if their nests are built near the electric towers. In addition, getting to remote objects may require a lot of scheduling optimization, such as identifying skilled SME(s) to reach the object's location, and/or taking the appropriate/suitable equipment to the object location, etc. As SMEs in power industries may be scarce experts, it may be important to allocate their skills and time optimally.

As the health condition of each component of every single object may play a vital role in a power supply chain, which may make it a cumbersome maintenance task for field SMEs, some powerline companies have used drones and other video and imaging methods as a viable alternative to collect images of their objects for SMEs to inspect later. For example, a power company may deploy a drone to take pictures of an electric tower, and an SME may inspect the electric tower for features of interest (e.g., potential damages, conditions, etc.) based on the pictures taken. However, at times, visual inspections and analysis performed by SMEs may be subjective, and the nature and/or the level of details may vary from person-to-person. In addition, it may be important for a streamlined maintenance process to have a standard analysis of images that provides consistent results across the object features. Recently, machine learning (ML) based inspection approaches have been explored in some industries. For example, an energy industry may use an ML model to assist SMEs with visual inspection of powerlines. However, fast and/or accurate image annotation have been one of the biggest and labor-intensive challenges to build an ML model driven tool.

When considering the creation of an ML model to assist the SMEs with the visual inspection, the related art has encountered several problems when trying to build an ML model that is capable of performing visual inspection with high accuracy.

A first issue with the related art is that an annotation process may be performed by annotators. An annotation process may refer to a process in which an annotator, such as an SME, reviews an image and identifies at least one subject matter of interest (which may also be referred to as “object of interest”) from the image. For example, the subject matter of interest may be a product/equipment, component(s) of the product/equipment, feature(s) of an object, and/or defects on the product/equipment, etc. After the annotator identifies at last one subject matter of interest, the annotator may annotate the at last one subject matter of interest on the image reviewed. For example, if an image composes an electric power tower with multiple cables and one broken cable which are considered as subject matters of interest, the annotator may annotate the corresponding portions of the image with labels such as “electric power tower,” “power cables,” and/or “defective cable.” Based at least in part on the annotation, an ML model may be able to identify whether there is a fault with the product/equipment. As such, the annotation process may be a vital ingredient for an accurate ML model. However, the annotation process using annotators may be very expensive and time-consuming.

A second issue with the related art is that there may be no multi-object detection for objects, components of objects, and/or features associated with objects (e.g., component conditions). For example, the related art may be able to provide an image of an object captured using a camera. However, the ML model may not be able to correctly identify different objects in the image, different components on an object, and/or a feature on an object or on a component of the object, etc.

A third issue with the related art is the difficulties in measuring the severity of a condition of an object or a component of the object on the field. For example, while an image sensor may provide a two-dimensional (2D) picture of an object, most of the features on the object may be easier to identify using three-dimensional (3D) pictures. Thus, while an ML model may be able to identify a feature on a component of an object, the ML model may not be able to identify whether the feature of interest (e.g. a defective condition) is minor that does not require any immediate action, or whether the feature of interest (e.g. a defective condition) is significant that requires an immediate action, etc.

A fourth issue with the related art is the difficulties in measuring a failure mode after the identification of multiple component conditions on an object. A failure mode may refer to a condition where one or more components of an object are defective/faulty that cause the object not to operate correctly. As such, a failure mode may be a composition of multiple anomalies. For example, an electric power tower may still work properly if there is a broken cable. However, the electric power tower may not work properly when there are multiple broken cables, or when there is a severe corrosion in addition to the broken cable. While an ML model may able to detect one or more object feature on an object, the ML model may not be able to determine whether the one or more object features constitute a failure mode for the object. For an ML model to be able to provide accurate and meaningful measurements to identify a failure mode, the ML model may require a deep understanding of the physical interactions between different components.

A fifth issue with the related art is that there may not be a system that is capable of monitoring the health of objects regularly to create a record or a realistic picture of the objects' health.

A sixth issue with the related art is associated with using drones to assist SMEs with object inspections. Drones may be highly capable edge devices that are capable of capturing images of objects at a far distance or height. However, drones need to be constantly monitored by SMEs (or drone pilots) to ensure that images of all objects have been captured and/or multiple angles of an object have been captured, etc. For example, drones for a power company may be constantly monitored by a group of SMEs to ensure that images of all transmission lines (or all objects at all locations) have been captured and each object is captured through multiple angles. Thus, the reviewing process in the field may remain laborious and there are chances of information loss.

A seventh issue with the related art is a lack of autonomous pipeline for object detection. As such, each stage of a pipeline for object detection may still require close human supervision.

An eighth issue with the related art is that a lot of information reading on objects of interest may still largely human based. For example, some industrial equipments may include meters that measure a variety of information (e.g., gas/water pressure, electric voltage, etc.), and reading of these meters may require humans in the field to collect measurements and read digital or analog gauges.

A ninth issue with the related art is that collection of data on the field may requires special equipment like drones and the data collection may not be a standardized process.

A tenth issue with the related art is that image and/or video analytics may be a time and compute intensive task and demands new innovative methods to speed up the training and inference processes for an ML model.

An eleventh issue with the related art is that an object inventory may demand a lot of effort from the back office and field engineering team to keep and maintain the object inventory updated. This invention addresses this problem by updating the current inventory using the image and video capture from the field.

To address the above issues, example implementations/aspects described herein involve an autonomous method/system to inspect multiple objects regardless of their geo-location and an end-to-end methodology to detect failure modes with high accuracy. Implementations/aspects described herein may be focused on assisting the SMEs by providing them with a complete autonomous pipeline to get the image and video analytics results and maintenance insights of objects with a minimum human intervention. For example, to address the issues of the related art, the example implementations/aspects described herein include at least the following aspects:
A. Continuous Annotation Procedure: one aspect of the present disclosure includes automating the annotation process with humans for the creation of an accurate ML model to assist the SMEs.
B. Transfer Learning Multi Object Detection Function: another aspect of the present disclosure includes detecting multiple objects of interest in a system to identify objects and object features of interest optimally using neural network weights trained from different domains to identify new objects and their object features of interest to solve new problems.
C. Automatic Severity Level Calculation based on Clustering Analysis: another aspect of the present disclosure includes a mathematical modeling-based system that enables automatic calculation of the severity of at least one feature detected on an object. Giving multi objective detection functionality, the same objects in an image may be extracted and computed from the other image(s) in a different angle(s). The object's severity score may be consolidated across and computed cohesively via sub-image merge and dedupe using the clustering analysis. Another aspect is to autonomously define the severity cohorts, using the distribution based techniques and clustering.
D. Failure Mode Identification: another aspect of the present disclosure includes using Bayesian networks in conjunction with the SME input to compute inference of the failure mode based on the object/object features.
E. Tracking of the Object Condition Over Time: another aspect of the present disclosure includes an automated system tracking that is capable of capturing information on an object and create a chart of the object condition over time to enhance the object degradation information provided to a user.
F. Automatic Meter Reading and Information Extraction: another aspect of the present disclosure includes is to capture important reading from the object. The ML based model allows to read the meters and extract the relevant information automatically through the images.
G. Autonomous Flight for Fleet of Drones Using Geographic Information System (GIS): another aspect of the present disclosure includes capturing an optimal image of an object for processing by an ML model using multiple drones. As it may be paramount to align multiple drones to the object with high precision, aspects presented herein is capable of configuring a fleet of autonomous drones to navigate between different objects using GIS and read the location markers on objects to automatically choose an optimal or suitable alignment.
H. Sensor Fusion Using Camera, Lidar and Infrared for Improvement of Model Precision: another aspect of the present disclosure includes using a combination of different sensors or sensing techniques to improve the accuracy of the object inspection. For example, by capturing a single object through multiple sensors, e.g., multiple cameras, multiple lidars (light detection and ranging), multiple infrared sensors, or a combination thereof, may provide additional information about the object and its environment. This may enable the inspection result to be more comprehensive and accurate.
I. End to End automated training and inference pipeline from autonomous flight drones or other sensors to capture images and videos to delivering the insights to the dashboard using on-premise and off-premise environments. The initial image pre-processing is performed on the edge to capture the degree of the quality of the sensor input and if needed, more data can be captured. Edge processing allows to preprocess the images and perform required corrections on flights (deduping, removing empty images, image quality check).
J. Continuous Training and Improvement of the Annotation. Detection of False Positive and False Negative Detection Using Human in the Loop (Not Automate) and Semi Supervised Learning (Automate): another aspect of the present disclosure includes using a combination of supervised and semi-supervised methods and sampling techniques to incorporate newness in the data and configure for the best detection model by keeping the computational strain to the minimal.
K. Innovation in Parallelization of Algorithm Processing Using Distributed System for Inference in Video Analytics: another aspect of the present disclosure includes using a distributed system processing to reduce the computational (training and inference) time to allow for the near-real-time analysis of the data.

Aspects of the present disclosure involve a method for autonomous visual inspection, the method involving receiving images autonomously captured via at least one image capturing device; identifying at least one object from the images autonomously based on a set of inference data from a machine learning (ML) module; identifying at least one feature of the at least one object autonomously based on the set of inference data; and initiating an alert autonomously if the at least one feature meets a defined condition or a threshold.

Aspects of the present disclosure involve a computer program storing instructions for an autonomous visual inspection, the instructions involving receiving images autonomously captured via at least one image capturing device; identifying at least one object from the images autonomously based on a set of inference data from an ML module; identifying at least one feature of the at least one object autonomously based on the set of inference data; and initiating an alert autonomously if the at least one feature meets a defined condition or a threshold. The instructions can be stored in a non-transitory computer readable medium and executed by one or more processors.

Aspects of the present disclosure involve a system for autonomous visual inspection, the system involving means for receiving images autonomously captured via at least one image capturing device; means for identifying at least one object from the images autonomously based on a set of inference data from an ML module; means for identifying at least one feature of the at least one object autonomously based on the set of inference data; and means for initiating an alert autonomously if the at least one feature meets a defined condition or a threshold.

Aspects of the present disclosure involve an apparatus for autonomous visual inspection, the apparatus involving a processor, configured to receive images autonomously captured via at least one image capturing device; identify at least one object from the images autonomously based on a set of inference data from an ML module; identify at least one feature of the at least one object autonomously based on the set of inference data; and initiate an alert autonomously if the at least one feature meets a defined condition or a threshold.

### BRIEF DESCRIPTION OF DRAWINGS

FIG. 1 illustrates an example continuous annotation procedure for an ML module in accordance with various aspects of the present disclosure.

FIG. 2 illustrates an example continuous annotation procedure for an ML module in accordance with various aspects of the present disclosure.

FIG. 3 illustrates an example continuous annotation procedure for an ML module in accordance with various aspects of the present disclosure.

FIG. 4 is a diagram workflow illustrating an example inference interpolation in accordance with various aspects of the present disclosure.

FIGS. 5A, 5B, 5C, 5D, and 5E are diagrams showing an example architecture that includes at least one transfer learning enabled multi-object detection model and a severity level calculation model that may be used by the system for autonomous object inspection and object feature detection disclosed herein in accordance with various aspects of the present disclosure.

FIG. 6 is an example end-to-end autonomous pipeline of object inspection and object feature detection associated with a fleet management in accordance with various aspects of the present disclosure.

FIG. 7 is an example creation of a model/configuration a drone or a fleet of drones takes flight to capture the images (of one or more objects or object features) in order to fly the drone autonomously in accordance with various aspects of the present disclosure.

FIG. 8 is an example autonomous flight in action and how are the images captured in accordance with various aspects of the present disclosure.

FIG. 9 is an example of capturing the results of the ML inference model for further processing and inferencing with the additional computing power of an edge device in accordance with various aspects of the present disclosure.

FIG. 10 is a diagram illustrating an example of training an ML module based on new images in accordance with various aspects of the present disclosure.

FIG. 11 illustrates a system involving a plurality of objects networked to a management apparatus, in accordance with an example implementation.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Aspects and example implementations presented herein provide an autonomous method, system, and apparatus for inspecting a set of objects and detecting failure modes associated with the set of objects with a high accuracy. For example, in one aspect of the present disclosure, a fleet of drones may be deployed to capture images/videos of at least one object autonomously. Then, based at least in part on the captured images/videos of the at least one object, an ML module may be trained to detect and monitor for feature(s) on the at least one object and identifying whether there is a failure mode for the at least one object based on the severity level of the object feature(s) detected or based on a defined combination (e.g., a combination of features on certain components). In some examples, the at least one object may include infrastructure objects, such as equipments and manufacturing components.

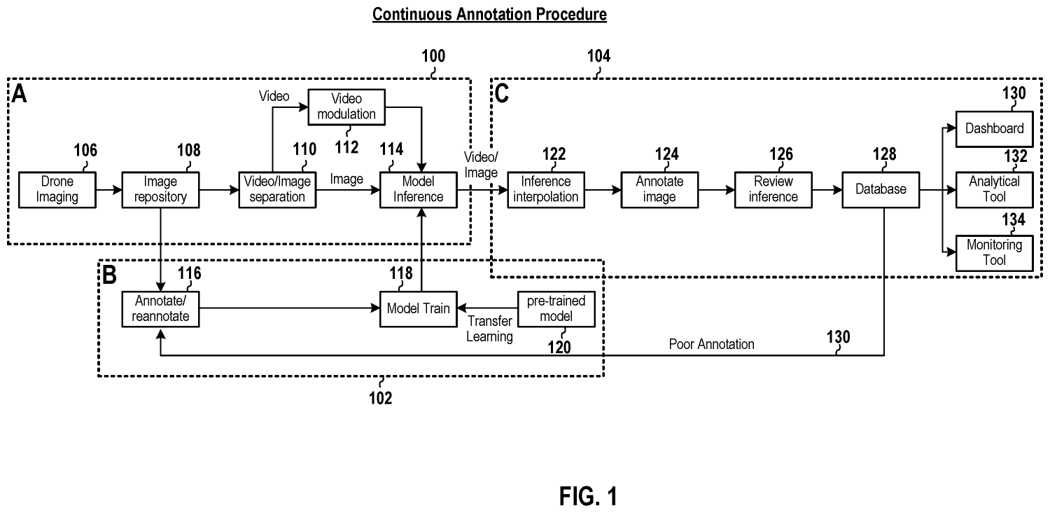

FIG. 1 illustrates an example continuous annotation procedure for an ML module in accordance with various aspects of the present disclosure. The system for autonomous object inspection and object feature detection disclosed herein may include a continuous annotation procedure that enables an ML module associated with the system to be trained to autonomously (or automatically) identify an object and/or features of the object based at least in part on the images of the object, where the images may be captured by at least one drone via an image capturing device (e.g., a camera, a video recorder). For purposes of the present disclosure, the term “module” may be used interchangeably with the term “model.” For example, the term “ML module” may be used interchangeably with the term “ML model.”

In one aspect, the continuous annotation procedure described herein may be illustrated with multiple process pipelines and sections, which may include a first pipeline A 100 that focuses on obtaining images of one or more objects used for ML model inference and ML model training, a second pipeline B 102 that focuses on the ML model training, and a third pipeline C 104 that focuses on the ML model inference. For purposes of the present disclosure, an “inference,” an “ML inference,” or an “ML model inference” may refer to a process of running data points into an ML model (e.g., via an inference host) to calculate an output such as a single numerical score, e.g., to use a trained ML algorithm to make a prediction. An “inference host” or an “ML inference host” may refer to a network function which hosts the ML model during an inference mode. A “training,” an “ML training,” or an “ML model training” may refer to a process of running data points to train or teach an ML model (e.g., via a training host). A “training host” or an “ML training host” may refer to a network function which hosts the ML model during a training mode.

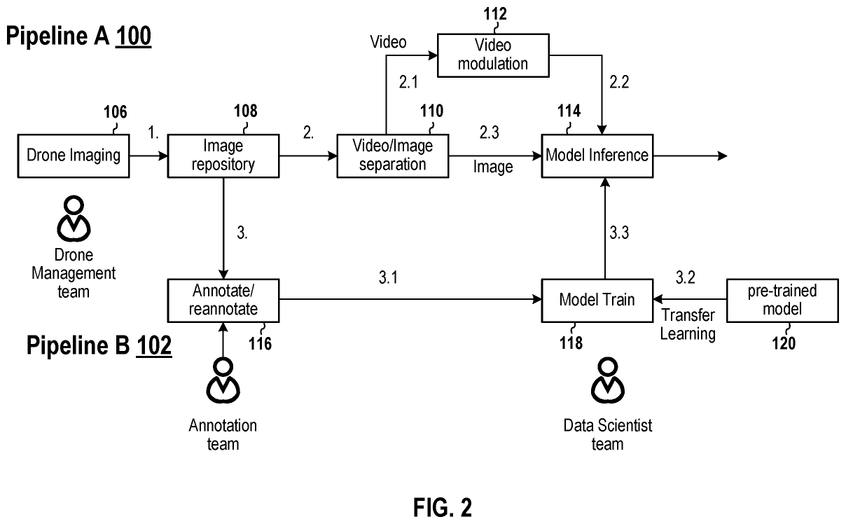

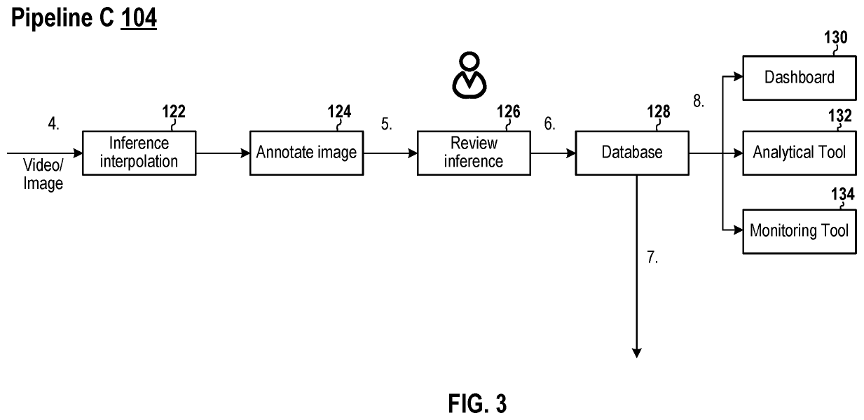

FIGS. 2 and 3 illustrate the pipeline A 100, the pipeline B 102, and the pipeline C 104 in greater details in accordance with various aspects of the present disclosure. In one example, an ML module may be trained to provide continuous annotation for the objects (e.g., the process of annotating at least one subject matter of interest on images that include the objects) and identification of the feature of the objector a failure mode of the object using a semi-supervised learning model as shown by FIG. 2. The subject matter of interest may include a product/equipment, one or more components of the product/equipment, and/or one or more feature of interest on the product/equipment, etc.

In one example, the ML module may initially be trained based on images of objects captured by at least one image capturing device, historical images (e.g., publicly available pre-annotated images), and/or based on previous trained ML module(s) (if available). Image capturing device may include a camera, a video recorder, or any type of device that is capable of capturing images. In some examples, the image capturing device may be located on a moving device, such as a drone, a rover, or a device capable of moving on a rail, etc. For example, as shown at 106 of FIG. 1 and FIG. 2, a drone or a set/fleet of drones may be used to capture images of one or more objects via image capturing device(s) on the drone(s), such as camera(s) or video recorder(s). For purposes of the present disclosure, the term “image” may include any types of visual data, such as a picture captured by a camera or a video/frame captured/recorded by a video recorder. While aspects described herein may use a drone or a fleet of drones to capture images of an object, it is merely for illustrative purposes. Other types of devices with image capturing capability may also be used in replacement with the drone(s). For example, images of an object may also be captured by a camera installed in proximity to the object or an inspection rover with a camera.

At 108, after obtaining the images of one or more objects, the images of the one or more objects may be stored in an image repository. In one example, if the images are captured by a drone, the image repository may either be on the drone itself (e.g., on a prem) or on a cloud repository based on the requirements or specifications. The images captured may be used for both ML model training and ML model inferencing.

For the ML model training (initial training or ML module updating), as shown at 116, the images of the objects captured (e.g., by an image capturing device or by a drone) and/or the historical images of the objects may be annotated by an annotator or a group of annotators, such as by placing labels for subject matters of interest on the images. The annotator may be an SME or a trained personnel that is capable of identifying and annotating one or more subject matters of interest on images. For example, if the subject matters of interest are associated with a vehicle, the annotation process may include identifying and annotating a vehicle in the image, components of the vehicle (e.g., windshields, tires, front hood, etc.), and/or feature(s) on the vehicle (e.g., a broken windshield, a dent, a flat tire, etc.).

At 118, after completing the image annotations, the annotated images may be transmitted to an ML training host that is associated with the ML module, where the ML training host may train the ML module (or the ML inference host of the ML module) to identify the subject matters of interest on an image by comparing the image to the annotated images. In some examples, as shown at 120, if there are one or more pre-trained ML modules/models, the pre-trained ML modules/models and/or their trained data may be used for transfer learning for the ML training and/or tuning of an image detection procedure/model. After the annotated images and/or the transfer learning are received by the ML training host, the ML module may be tuned or updated to detect the objects or the subject matters of interest correctly, and then the ML module may be saved and used as an ML inference host.

After the initial training or updating of the ML module, the ML module may be used to assist in the creation of the annotations for the future images. In other words, the trained ML module may be used for performing the ML inferencing. For example, as shown at 110, after images of objects are captured and stored in the image repository (the images may be new images that are different from the images used for ML training), a set of images or frames from the image repository may be extracted for further processing and identifying if the extracted images is a video or a picture. In one example, as shown at 112, if the extracted images/frames is associated with a video, the video may further be modulated such that the frames of the video may be compressed, or frame per second (FPS) of the video may be modified. The modulation of the video may reduce the amount of processing (or inferencing) to be performed by the ML module. After the video is modulated, the modulated video may be transmitted to the ML module for inferencing.

At 114, after receiving the images (e.g., pictures and/or modulated videos) from the image repository, the ML module (or the ML inference host associated with the ML module) may automatically annotate the images to identify the subject matters of interest.

In one example, as shown at 122 of FIGS. 1 and 3, after or during the ML module or the ML inference host annotates the images, an inference interpolation mechanism or process may be applied to the inference process to improve the efficiency and accuracy of the inference process.

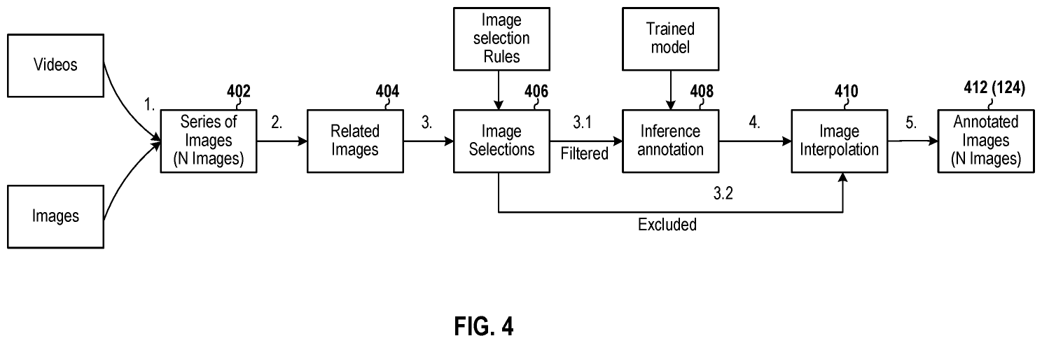

FIG. 4 is a diagram workflow illustrating an example inference interpolation in accordance with various aspects of the present disclosure. At 402, videos and pictures may be transmitted to an interpolation module (or entity) as an input for the interpolation in the form of batch and/or series of images.

At 404, the interpolation module may collect the images in the form of batches which are related (e.g., in sequence with the help of metadata). For example, the interpolation module may group images associated with a first type of object (e.g., electric power towers) to a first batch of images, images associated with a second type of object (e.g., power converters) to a second batch of images, and images associated with a third type of object (e.g., power cables) to a third batch of images, etc.

At 406, after the related images are batched together, two process happens on interpolation module: a filtering process and de-duplication process. For the filtering process, the interpolation module may filter the related images into a filtered section and an excluded section, where excluded images may not be passed to the inference module. The filtering of the related images may be based on one or more image section rules. For example, for a group of power cable images, the interpolation module may separate them into a set of images to be included for inferencing (e.g., images with proper resolution and/or components) and a set of images to be excluded for inferencing (e.g., images without proper resolution and/or components). For de-duplication process, the interpolation module may remove all the de-duplicated images using comparison using location and context information between several pictures that were taken from the same object of interested in the same batch. The related images into a filtered section and an excluded section, where excluded images may not be passed to the inference module. For purposes of the present disclosure, a de-duplication process may refer to a process of removing duplicated pictures. For example, if an image capturing device, such as a drone with a camera, captures images of an object from multiple angles, a de-duplication process may delete one or more images of different angle of the object.

At 408, the ML module may run the ML model inference on the filtered images. In some examples, the image filtering may further be based on one or more additional criteria, such as the object type, the time stamps, the metadata associated with the object, the location of the object (e.g., the GIS location), and/or the severity (or a condition level) of the features of the object, etc. and the annotated images are passed to the next state.

At 410, the ML module (or the interpolation module) may identify a relationship between annotated images and unannotated images, and the ML module (or the interpolation module) may create annotation boxes for the unannotated images based at least in part on the relationship identified. In some examples, the relationship may be based on metadata, time stamps, latitude, longitude, lens angle, etc. associated with the objects or subject matters of interest.

At 412, after the images are annotated, the annotated image may be stored for further processing. In some examples, 412 of FIG. 4 may correspond to 124 of FIGS. 1 and 3.

Referring back to FIGS. 1 and 3, in some scenarios, a shown at 126, after the images are annotated, the annotated images may be reviewed by a reviewer or a group of reviewers to identify whether the inference is accurate, or whether the inference is accepted or rejected. For example, a person may review the annotations on an annotated image to identify whether the annotations correctly label each subject matter of interest. If the annotations are correct, the person may accept the annotated image, whereas if the annotations include error(s), the person may reject the annotated image.

At 128, the annotated images may be saved in a database. In some scenarios, as shown at 130, the annotated images that are being rejected (e.g., annotated images tagged with a rejection) may be sent to the ML training host from the database for reannotation. Those images after reannotation may be used to retune (e.g., retrain or update) the ML module for the new data. This may enable the ML module to be continuously trained without starting from scratch, and the annotation precision of the ML module may continue to improve over time.

After the annotated images are stored in the database, the annotated images may be accessed by users in one or more formats. For example, a user may access or utilize the annotated images via a dashboard 130, an analytical tool 132, and/or a monitoring tool 134, etc.

The continuous annotation procedures described in connection with FIGS. 1 to 4 may enable an ML module to be trained to annotate images captured by image capturing devices such as drones with cameras based on a semi-supervised learning. In summary, after the initial training of the ML module, new images (e.g., images captured by drones for one or more objects) may passed through an inference pipeline (e.g., the pipeline A 100 and/or the pipeline C 104) for inference (e.g., for annotation) and the inference may be reviewed by an annotation team. The annotation team may accept or reject each inference, such as identification of object of the annotated image. If the annotation team rejects the annotations created by the inference pipeline and after identifying the correct annotations, the annotation team or the ML module may update the annotations, save the image with the new annotations, and pass the images to the training pipeline (e.g., the pipeline B 102). These new images may provide data supplementation using the newness of the data with the help of a human in the procedure/loop. On the other hand, if the annotation team accepts the annotations created by the inference pipeline, then those results may be presented to a user or a customer for further understanding of the object condition and to create performance measures to monitor the ML module health. For example, an ML module health may be captured through metrics like root mean square error (RMSE), accuracy, precision, recall, and/or F1 score, etc., to ensure that the ML module performance is steady over time. When the ML module performance starts to degrade, the ML module may be considered as ‘unhealthy’, which may indicate the need of an ML model retrain/update. In some scenarios, in case of video analytics, an interpolation method may be used to hasten the process of running the inference, such as described in connection with FIG. 4. For example, based on the frame per second property of the video, the number of frames to be annotated in the video may be too high for the inference pipeline to be able to keep up. In another example, to supplement the lack of available images and to speed up the process of the training the ML module, publicly available pre-annotated images may be used along with pre-trained ML modules for transfer learning. In addition, annotation suppression methods may be used to extend the number of classes from the pre-trained ML modules to the newly trained ML module.

In another aspect of the present disclosure, the ML module described in connection with FIGS. 1 to 4 may further include, or be associated with, a multi-object detection function (or module) that is capable of identifying one or more subjects of interest on an image, an automatic severity level calculation function (or module) that is capable of determining severity level of an object feature detected, and/or a failure mode identification function (or module) that is capable of identifying whether a failure mode has occurred on one or more objects.

In one example, a Bayesian calibration may be used for the multi-object detection function, where the Bayesian calibration may be refer to an application of Bayes' theorem, which relates prior information with uncertainty to future information based on the likelihood of observed outputs from a model. In other words, Bayesian statistical methods may use Bayes' theorem to compute and update probabilities after obtaining new data. For example, for a Bayesian calibration probability calculation method for a class (e.g., an object, a subject matter of interest), class probabilities from a classification model may be used as a prior probability in a Bayesian probability calibration process, together with the object detection model class probability, to update a final probability of having specific type of feature of interest on an object. In some examples, object class distribution, object feature class distribution, and/or object feature class distribution associated with a specific object type may be taken into consideration in this process. In other examples, predicted bounding boxes may be suppressed by utilizing suitable suppression method(s) to ensure one final bounding box is to be outputted for each prediction.

For the automatic severity level calculation function, inference of the images may be based on object detection in heuristic and deep learning approaches. For example, calculation of an actual size of an object feature may be based on physics models (e.g., optics), calculation of a percentage area of an object feature condition (e.g., a rusty condition) may use ruled based approach (e.g., computer vision techniques-pixel-based calculation) or based on a segmentation model (e.g., deep learning techniques using a convolutional neural network architecture (e.g., Fast Region-based Convolutional Neural Network (RCNN)), and calculation of the number of components of object with feature of interest may be based on comparing the defected components to normal components. The severity cohorts by object or object feature may be autonomously defined using these distribution-based or clustering techniques.

For the failure mode identification function, identification of multiple features of interest and severity level of the object feature may be used for identifying a failure mode, and/or with the help of historical data. In addition, the failure mode identification function may further include execution prescriptive analytics to provide remediation (e.g., a contextual knowledge center) for an identified failure mode.

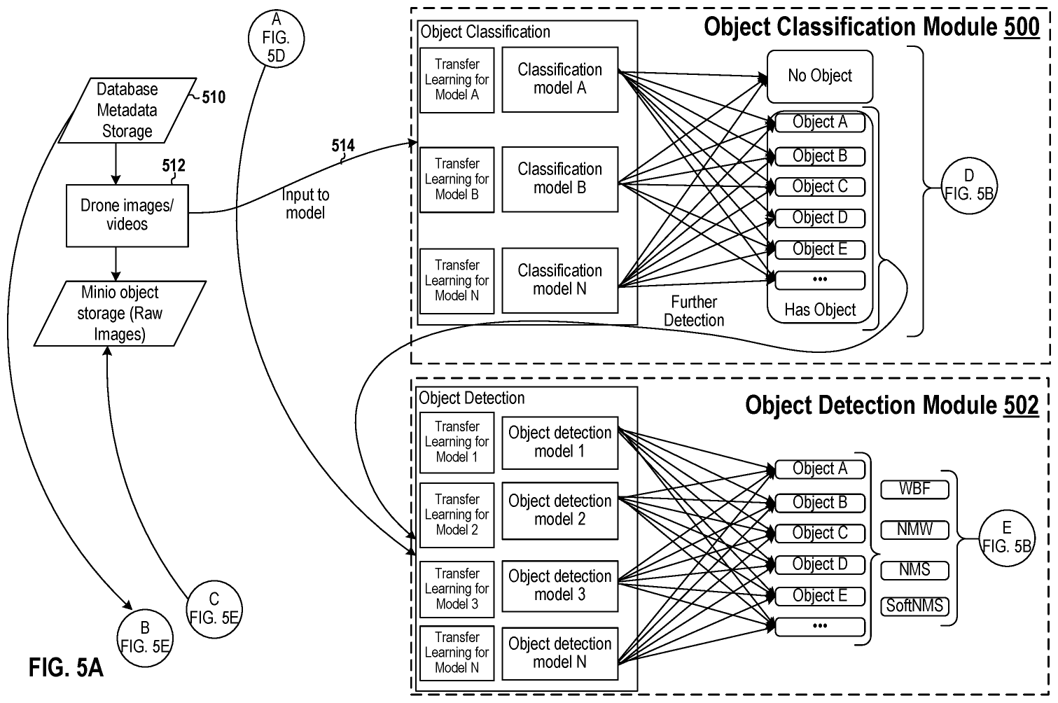

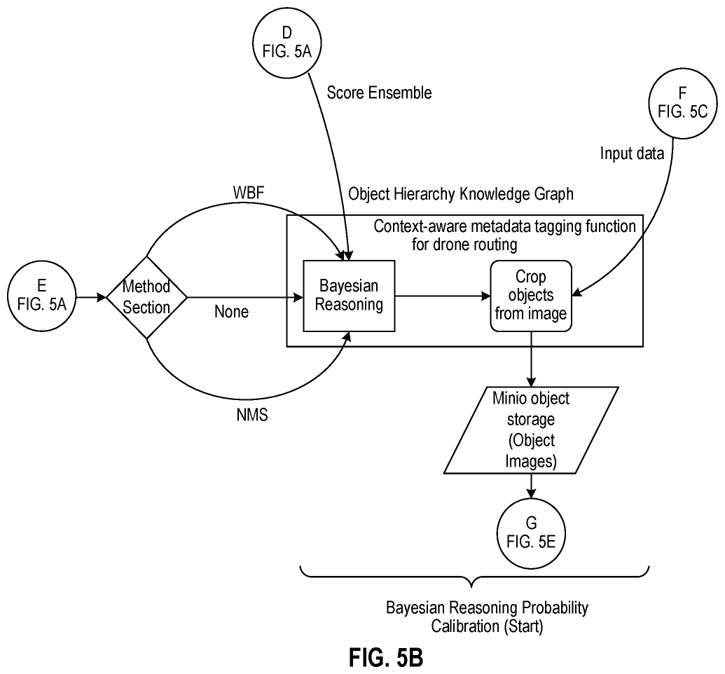

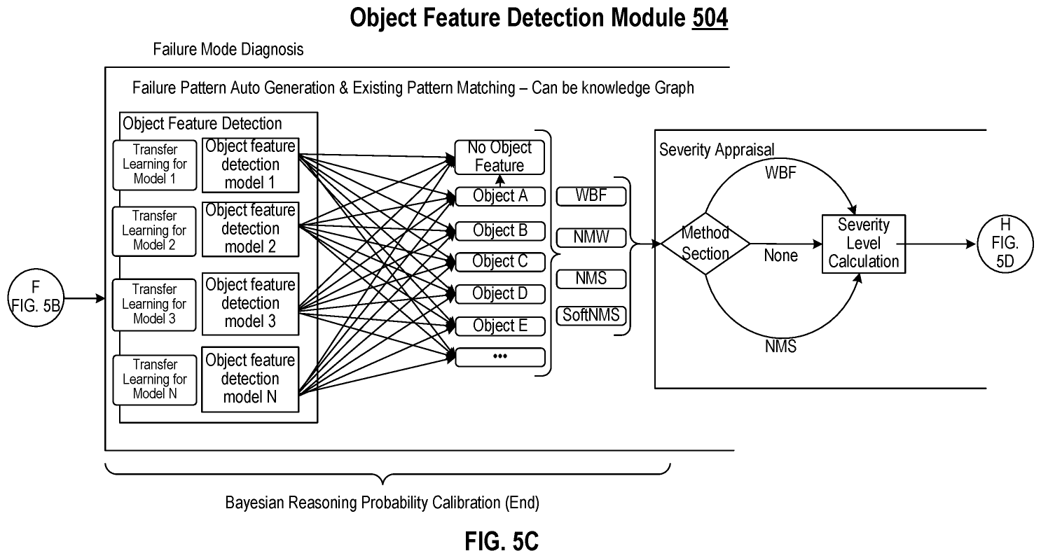

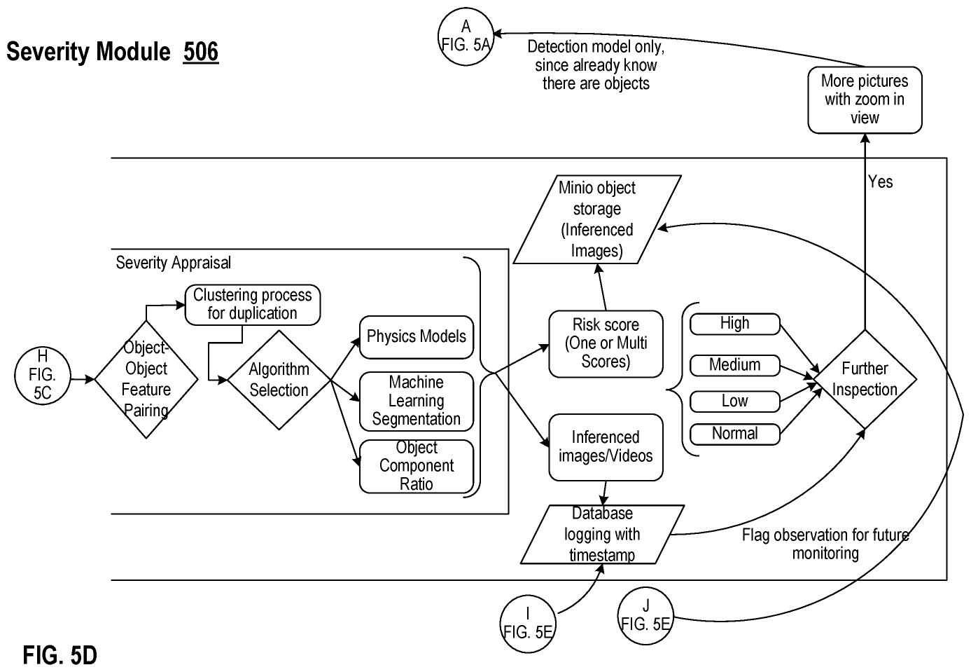

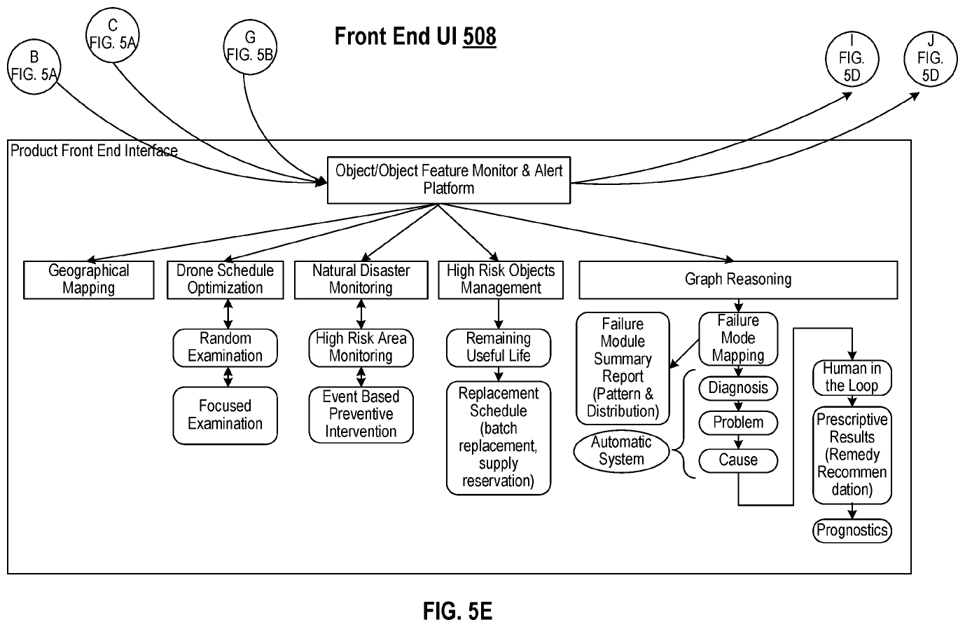

FIGS. 5A, 5B, 5C, 5D, and 5E are diagrams showing an example architecture that includes at least a multi-object detection model and a severity level calculation model that may be used by the system for autonomous object inspection and object feature detection disclosed herein in accordance with various aspects of the present disclosure. The example architecture may include at least an object classification module 500 that is configured to classify one or more subject matters of interest on images, an object detection module 502 that is configured to detect one or more subject matters of interest in the images, an object feature detection module 504 that is configured to identify one or more features on the one or more subject matters of interest, a severity module 506 that is configured to calculate a severity level for the one or more object features, and a front end user interface (UI) 508 (which may also be referred to as a monitor and alerting platform) that is configured to provide a control or access interface for a user.

Referring to FIG. 5A, to provide ML module training to the object classification module 500 and/or the object detection module 502, as shown at 510 and 512 (and described in connection with FIGS. 1 to 4), a training dataset (e.g., the image repository at 108) that is used for training an ML module may include new images acquired from an image capturing device (e.g., a drone with camera), or samples from historical image storages, or a combination of both at a defined ratio. Then, as shown at 514, the images from the image capturing device and the samples from the historical image storages may be used as an input data source that is to be provided to the object classification module 500 for object classification and to the object detection module 502 for object detection. In one example, the images and/or the samples may be provided to the object classification module 500 and the object detection module 502 in parallel to expedite the ML model training process, which may be very time consuming in some examples.

For the object classification module 500 and/or the object detection module 502 to provide ML inferencing (e.g., for object classification and/or detection), inferencing data may be provided to the object classification module 500 and the object detection module 502 in sequence. For example, the object detection module 502 may be configured to be invoked/triggered for performing ML inference for a set of images only when the object classification module 500 classifies that there are objects in the set of images. In one example, the object detection module 502 may compose only one or multiple computer vision image detection models from different algorithm families. Similarly, the object classification module 500 may compose only one or multiple deep learning classification models from different algorithm families.

In another example, as shown by FIG. 5B, for the object detection module 502 to perform the object detection, a probability score fusion may be applied across a plurality of object detection modules (if multiple object detection modules are deployed), or within one single object detection module, depending on the number of modules built, as well as which suppression method is chosen. In some examples, additional weighted boxes fusion (WBF) and/or non-maximum suppression (NMS) mechanism may be applied to get a final probability. Then, the classification results from the object classification module 500 and the object detection results from the object detection module 502 may be ensembled with Bayesian reasoning with considering object class distribution. Weight assignment to different modules may be fine-tuned as specified. In some examples, depending on the use cases and/or model performance requirements, individual object modules/models may be built for uncommon object type, or object not fit into generic object-object features relationship.

Referring to FIG. 5C, the object feature detection module 504 may be configured to detect one or more object features on one or more subject matters of interest. For providing an ML training to the object feature detection module 504 (e.g., training to identify the object feature), a training dataset that is used for training the ML module may include new images acquired from an image capturing device (e.g., a drone with camera), or samples from historical image storages, or a combination of both at a defined ratio. After input data source is selected, object of interest (or subject matters of interest) may be selected from the images with some buffer areas near the object from original images, and original object feature coordinates may be updated based on the updated image size.

For the object feature detection module 504 to provide ML module inferencing (e.g., for object feature of interest detection), output inferencing data from a last/previous module may be selected based on predicted object coordinates with adding some buffer area. Then, the object feature detection module 504 may train and/or provide inference base on the filtered images instead of raw output images from last/previous module. In some examples, the object feature detection module 504 may compose only one or multiple computer vision image detection modules from different algorithm families. Similarly, for the object feature detection module 504, a probability score fusion may be applied across a plurality of object feature detection modules, or within one single object feature detection module, depending on the number of modules built, as well as which suppression method is chosen. In some examples, additional WBF and/or NMS mechanism may be applied to get a final probability. Similarly, depending on the use cases and/or model performance requirements, individual object feature models may be built for uncommon object feature type, or object not fit into generic object-object feature relationship. In addition, Bayesian reasoning may also be applied to further calibrate final probabilities with considering output results from object classification and object detection modules if an improved performance is observed.

Referring to FIG. 5D, the severity module 506 may be configured to determine the severity level for an object feature of interest detected. In one example, the severity module 506 may include one or more model-based algorithms and non-model-based algorithms. For example, the severity module 506 may include one or multiple algorithms, such as a physics model based algorithm, rule based model algorithm, a deep learning model based algorithm, or a combination thereof. In one example, the severity module 506 may provide at least two types of output: a risk score output and an inferenced images output with severity overlay. For example, after detecting one or more feature of interest on an object, the severity module 506 provide a score (e.g., from 1 to 100 or 1 to 10) or a level (e.g., low, medium, high, etc.) for the one or more feature of interest to indicate the severity of the feature of interest. In one example, if the severity score for a feature of interest is high or exceeds a default threshold, at least one image capturing device, such as a drone or a rover with camera, may be triggered to take more detail images of the feature of interest for further investigation and/or for validating detected features of interest.

Referring to FIG. 5E, the front end UE 508 may be configured to provide a monitoring and alerting platform to an user, where the user may have access to the annotated images, data associated with objects (e.g., conditions of the objects, features on the objects, severity levels of the object features, etc.), and/or assessments/predictions for the objects. For example, the front end UE 508 may include a platform with features like geographical mapping, drone schedule optimization, natural disaster monitoring, risky object management, remaining useful life prediction, failure mode report, entity relationship mapping, or a combination thereof. In one example, the front end UE 508 may create knowledge graph/graph database utilizing database and object storage records.

In another aspect of the present disclosure, the system for autonomous object inspection and object feature detection disclosed herein may further be configured to track object condition over time. For example, for a remain useful life of an object of interest, the system may schedule a periodic inspection for the object by using at least one image capturing device (e.g., a drone or a rover with camera) to capture images of the object at a defined periodicity or at certain times. The scheduling of the inspection for the object may also be optimized based on historical information of the inspection and maintenance services. In one example, if the system (or the object feature detection module) detects a feature of interest but determines that the severity level of the object feature does not meet a certain threshold, the system may schedule images of the object with feature of interest to be taken at a defined periodicity or at certain times. In another example, the system may assign or provide a risk scoring for the object condition, such that it may be easier for a user to identify the condition of an object. For example, the risk score may range from one (1) to ten (10), where one indicates the object is in a good condition and ten indicates the object is in a poor condition, or vice versa.

In one example, for images that run through the inference pipeline discussed in connection with FIGS. 1 to 4, their latitude, longitude, date and time of when the images are taken, the images themselves, and/or objects metadata may be saved in a database. Then, a dashboard may publish key performance indicators (KPIs) for a set of objects showing objects conditions over time (e.g., a time graph showing how KIPs are changed for an object over a period of time).

In another example, based at least in part on the time series information regarding the conditions of an object, it may be possible to compute the degree of the object's degradation and assign a threshold score to the object. For example, in Jan. 13, 2020, at a tower XYZ, the dampers had an overall 50% rusty and in Jan. 13, 2021, at the same tower XYZ, the dampers had an overall 60% rusty. Thus, it may be concluded that the dampers have an increase of 10 basis points of the rusty condition.

In another aspect of the present disclosure, the system for autonomous object inspection and object feature detection disclosed herein may further be configured to perform automatic meter reading and information extraction on one or more objects. For example, some of the objects may be associated with at least one meter that identifies one or more parameters associated with the object (e.g., a water pressure meter showing the water pressure in a pipeline, a voltage meter showing the voltage that is running through a cable). An image capturing device (e.g., a drone, a rover, a stationary camera) may be configured to take images (e.g., pictures or videos) of the at least one meter periodically or at specified times. Then, an ML module may be trained to identify the readings on the at least one meter and record the readings in a database. In some examples, for an object feature detection module do determine whether there is a feature of interest on an object and/or for a severity module to determine the severity level of an object feature, the readings on the meter of the feature may be taken into consideration (e.g., irregular water pressure or power voltage may identified as a particular object feature and/or assigned with a higher level of severity). In another example, the meter reading may also include confirming the status of a meter.

As described in connection with FIGS. 1 to 4, images of objects may be captured by at least one image capturing device, which may include a drone or a fleet of drones equipped with camera(s). As such, in another aspect of the present disclosure, the system for autonomous object inspection and object feature detection disclosed herein may be associated with a fleet of drones that is capable of autonomous flight. For example, one or more drones may be configured to autonomously fly to an object and take pictures of the object at a scheduled periodicity or at defined times. In one example, for a drone to locate an object (or travel to a designated location), the geographic information system (GIS) information along with the object information may be used for automating the positioning of the drone in the right place and the location for image capturing. The GIS may refer to a system that is capable of creating, managing, analyzing, and/or mapping all types of data along with the geographically associated metadata. For example, a GIS may connect data to a map, integrating location data (e.g., where objects are) with all types of descriptive information (what objects are like there). This provides a foundation for mapping and analysis that may be used in an industry. Thus, the GIS may help users understand patterns, relationships, and geographic context regarding one or more objects.

In another example, a drone may be able to locate an object (or travel to a designated location) based on a landmark-based anchor, such as a radio frequency identification (RFID) and/or quick response (QR) codes. may also be used for guiding the drones, such as placing the RFID/QR codes on objects and/or on routes to the objects. For example, a drone or a fleet of drone may use one or more landmark-based anchors (e.g., RFID and/or QR codes) to determine a most suitable surveillance approach and route for capturing images for an object and/or a feature. The landmark-based anchor may also enable a drone to address certain features object features such as misalignment. For example, a best practice procedure to take pictures and videos for an object or a set of objects (e.g., a misaligned insulator) may be defined for a drone or a fleet of drones. In some examples, images taken by the drone(s) may further be improved or corrected based at least in part on the location of the object. For example, a procedure of correction of quality of images of an object (e.g., intensity and direction of light source over the object such as removing shadows) may be configured for a drone or an image processor based on the time, landmarks, latitude position, longitude position, and/or orientation of the object. In another example, drone operator may deploy the drone on the field and use one or more land markers and GIS to route the drone into right direction(s) for objects (e.g., electric towers) close to the land/take off landmark.

In another example, the inference pipeline or a portion of the inference pipeline discussed in connection with FIGS. 1 to 4 may be processed on edge (or based on edge computing). Edge computing may refer to a distributed information technology (IT) architecture in which client data is processed at the periphery of the network, as close to the originating source as possible. For example, model distillation for model compression and deployment associated with the ML module (a process of transferring knowledge from a large model to a smaller one) may be performed on edge.

In another example, the amount of evidence collected by a drone or a fleet of drones for an object feature may be configured to depend on a confidence level of the object feature detection. For example, if there is a high confidence level of an object feature detection (e.g., the probability of the object feature exceeding a threshold), a drone may be configured to collect more evidence on that object feature, such as taking more pictures of the object and the object feature, and/or using additional sensors (e.g., lidar sensors, infrared sensor) to obtain additional information (e.g., size, temperature) about the object feature.

In another example, at least one other type of information may be used in conjunction with the GIS information to improve the accuracy of the system disclosed herein. For example, while the ML module is performing inferencing on a set of images of an object, the ML module may take into consideration the GIS information related to the object and the weather information on the day the set of images are taken. In addition, the combined GIS information, weather information, object information and inference information may also be used for detecting errors in the ML module. For example, an image feature of interest identified by the ML module may be due to a snowing day that covers an object or a portion of the object with snows, which may appear as a feature of interest to the ML module. By taking the snowing day into consideration, the ML module may be able to determine or learn that such condition (e.g., the object covered by snow) does not constitute a feature of interest.

The system for autonomous object inspection and object feature detection disclosed herein may further include a user interface (UI) and/or user experience (UX) design for continuous display of the inferenced images (e.g., photos or videos) from a fleet of drones with GIS information. The system may be configured to generate alerts by object feature type based on the inferenced images. In addition, the information may be blended with sensor fusion, such as with lidar, image, video, and acoustic (discussed below). Also, the management of the fleet of drones may be based on a near real-time inspection and batch inspection, where both kind of inspections may be blended in the analysis (or inference). In some examples, the inspection schedule, such as image capturing schedule, scanning schedule (e.g., scheduled scan/ad hoc scan), and/or flight path for a drone or a fleet of drone may be based on the complexity of the ML module, kind of sensor(s) used by the drone(s), and/or inference speed.

In another aspect of the present disclosure, the precision of object and object feature of interest detection may further be improved by utilizing different types of sensors. For example, in addition to taking images of an object or a feature of the object, an image capturing device may further include, or be associate with, an infrared sensor (or infrared cameras) that is capable of calculating/measuring the temperature of an object or an object feature or a lidar sensor that is capable of calculating the distance between an object and the image capturing device (e.g., a drone), distance between different objects, size of an object feature, and/or the volume of objects and object features, etc. For example, a drone may be equipped with at least one camera, one infrared sensor, and one lidar. Thus, when the drone is configured to take images of an object or a feature of an object, the drone may also measure the size and the temperature of the object or a feature of an object. In some scenarios, a lidar may be able to identify certain failure modes more accurately than convolution neural networks (CNN) models. For example, a lidar may be configured to identify a broken object, a missing object, and/or misaligned objects, etc. In addition, a lidar may provide an X, Y, Z coordination information of objects and provide additional information of different kind of the object features. The infrared sensor may also be used for detecting the temperature and humidity of the environment surrounding an object (e.g., temperature and humidity in distribution lines like transforms and substations).

For purposes of the present disclosure, using a plurality of sensors may be collectively referred to as a “sensor fusion.” The sensors may include, and are not limited to, lidar sensors, cameras, video recorders, acoustic sensors, heat sensors, barometers, infrared sensors, and/or ultrasound sensors, etc. Information collected by a sensor may be referred to sensing information. For example sensing information collected by a heat sensor may be related to temperature of an object or a particular feature on an object.

In one example, the accuracy of ML inference outcome may also be improved based on sensor fusion. For example, an ML inference host may use sensing information with a sequence of images (or frames) to detect whether there is a false positive (FP) (e.g., inferencing a defective condition as a normal condition) or a false negative (FN) in an image (e.g., inferencing a normal condition as a defective condition) based on the inferences on a previous image (image N−1) and a next image (image N+1), the image being image N.

In another aspect of the present disclosure, the system for autonomous object inspection and the object feature detection disclosed herein may further be configured to provide an end to end inference pipeline from images captured by image capturing device(s) (e.g., drones with cameras) to a dashboard (e.g., a UI) based on a cloud environment.

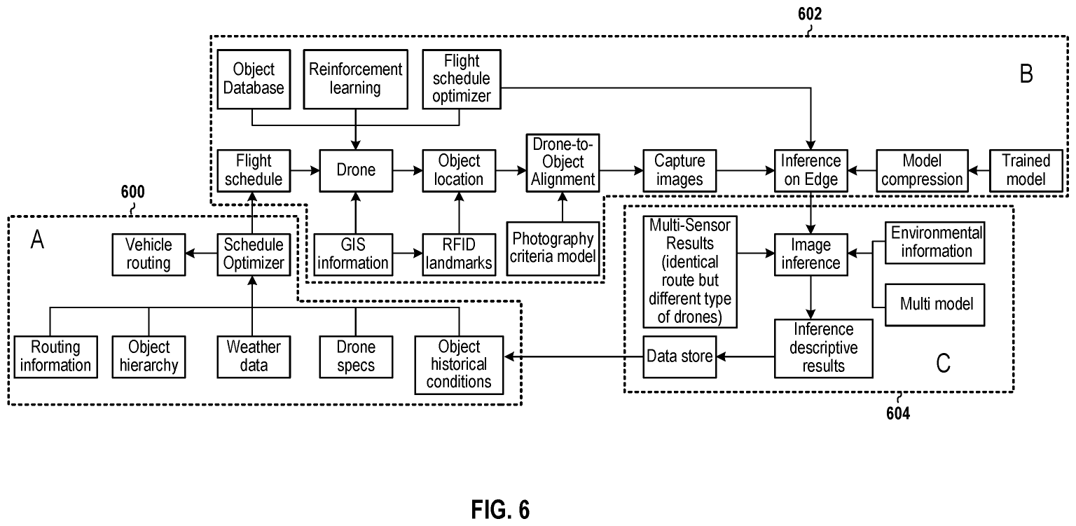

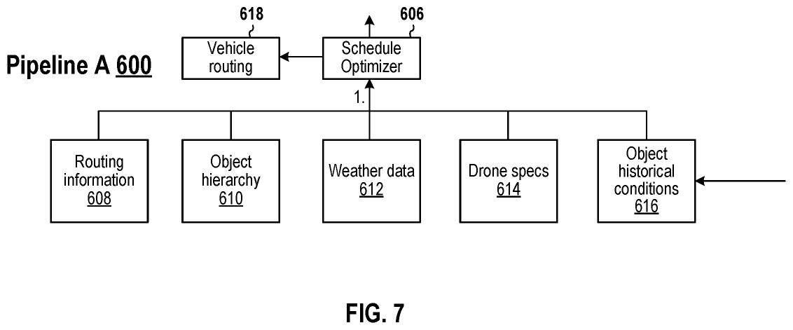

FIG. 6 is an example end-to-end autonomous pipeline of object inspection and object feature detection associated with a fleet management in accordance with various aspects of the present disclosure. In one aspect, the end-to-end autonomous pipeline described herein may be illustrated with multiple process pipelines and sections, which may include a first pipeline A 600 that focuses on an autonomous drone flight, a second pipeline B 602 that focuses on capturing images via the autonomous drone flight, and a third pipeline C 604 that focuses on optimizing the flight path for the autonomous drone flight. FIGS. 7, 8, and 9 illustrate the pipeline A 600, the pipeline B 602, and the pipeline C 604, respectively, in greater details. While the example presented herein uses a fleet of drones as an example, aspects presented herein may also apply to other types of image capturing devices, such as rovers and railing devices with cameras.

Referring to FIGS. 6 and 7, the pipeline A 600 illustrates an example creation of a model/configuration (e.g., an autonomous flight model/configuration) before a drone or a fleet of drones takes flight to capture the images (of one or more object or object feature of interest) in order to fly the drone autonomously. This model/configuration may be run with a specified computing power. In one aspect, as shown at 606 of FIG. 7, to create a flight schedule with optimized settings, several variables may be taken into account. For example, the variables may include, and are not limited to: (a) routing information 608—the path on which the objects lay and the terrain; (b) objects hierarchy information 610—to understand the objects to be inspected or relationship between objects; (c) weather data 612—this may affect the flight plan and/or the object condition; (d) drone specification 614 (or image capturing device specification)—to understand the capabilities of the drone to the full capacity; and/or (5) historical condition of the objects 616. After considering one or more variables, a schedule optimizer (or a computing entity) may create a most suitable or an optimal schedule of the drone flight. The schedule optimizer may also target variables like the path to the object, time of flight, etc. As such, with the assistance of the schedule optimizer, a routing for drones and vehicles (as shown at 618) may be optimized.

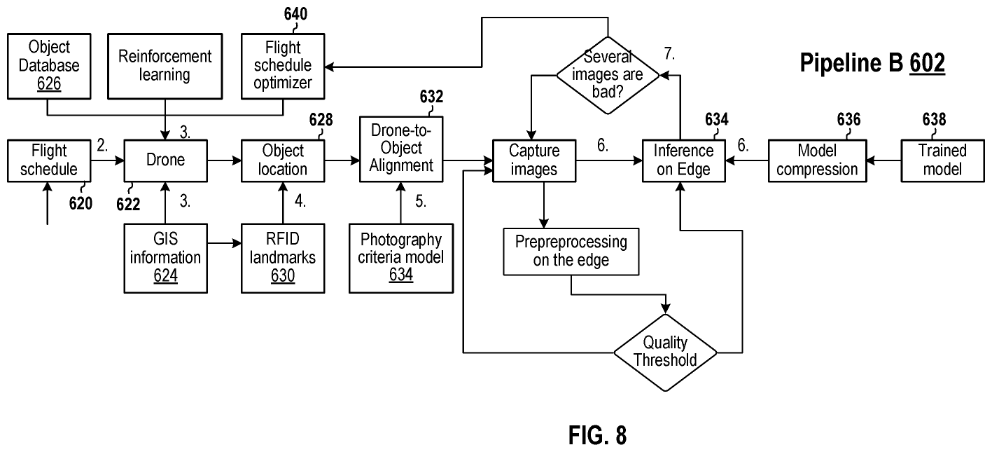

Referring to FIGS. 6 and 8, the pipeline B 602 illustrates an example autonomous flight in action and how are the images captured. In one example, the processing for the pipeline B 602 may be done on edge. As shown at 620, once the flight schedule is optimized, the flight schedule may be transferred to a drone or a set of drones (collectively as drone(s)). At 622, the drone(s) may takes in GIS information 624 to route to a correct location of an object and uses an object database 626 and/or an inflight scheduler, with drone's working orders and working plans, to re-align itself and recreate the optimized flight path if needed. At 628, the drone(s) may moves to the location of the object with the help of the stored GIS information 624 and/or land-mark based anchors (e.g., RFID markers 630). At 632, based at least in part on a photography criteria model 634, the drone(s) may align to the object and take images (e.g., raw image resolution is 12 mega pixels). In one example, the photography criteria model 634 may be based on the resolution specified for the object, the number of images (e.g., photos, videos) needed for the object, etc. At 634, once the images are captured, the captured images should be sent to the quality check process for automatic review of the image quality, it the image quality is acceptable then may be sent to the image goes to an ML inference model, such as described in connection with FIGS. 1 to 4. In some examples, as shown at 636 and 638, as image detection models may be computationally expensive, a compressed version of a trained image detection model may be run on edge. For this option, it is called in-flight Object Detection on drones. The drone runs the inference on the edge and based on a ruled-based threshold it is compute an object and feature of object that it is need to capture. At 640, the inference results may be sent to the in-drone flight schedule optimizer to take additional pictures of the objects if needed.

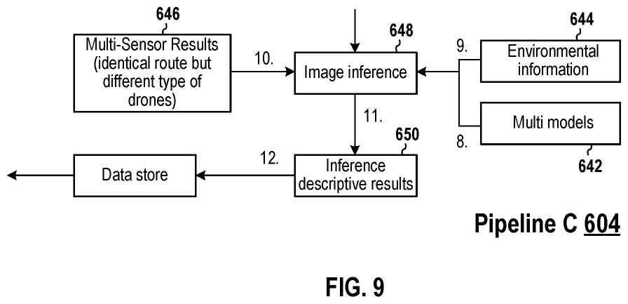

Referring to FIGS. 6 and 9, the pipeline C 604 illustrates an example of capturing the results of the ML inference model for further processing and inferencing with the additional computing power of an edge device. It could be done either on prem or on the cloud as needed. As shown at 624, one or more trained multi-sensor models may be utilized to enhance the information and understanding obtained/extracted from an image. In addition to the multi-sensor models, the additional models may also be used, such as remaining useful life models, object severity detection models, etc. As shown at 644, environmental information (e.g., time of the day, weather etc.) may be used to fully understand the contrast in the image and compare it to previously captured images of the same objects. As shown at 646, multiple drones, with the different sensor types may be flown on an identical route to capture additional information on the object. At 648, based at least in part on the multi-models (at 642), the environmental information obtained (at 644), the multi-sensor results obtained (at 646), or a combination thereof, the knowledge gained from the image may be enhanced and the inference may be obtained. At 650, based on using sensor fusion techniques, the inference may be captured in the form of descriptive results and the results may be stored in a data store (e.g., a database).

In another aspect of the present disclosure, the system for autonomous object inspection and object feature detection disclosed herein may include continuous training and improvement of the annotation as described in connection with FIGS. 1 to 4. For example, detection of false positive and/or false negative may be based on using human in the training/learning loop (e.g., not automate) and based on a semi supervised learning (e.g., automate).

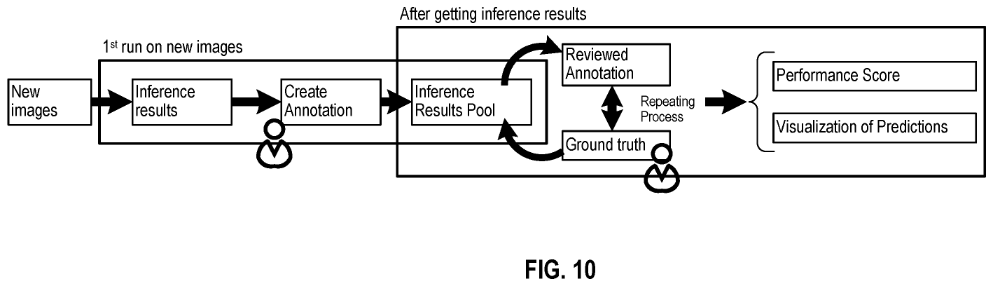

FIG. 10 is a diagram illustrating an example of training an ML module based on new images in accordance with various aspects of the present disclosure. As described in connection with FIGS. 1 to 4, new images of an object (e.g., captured by at least one image capturing device, such as a drone with camera) may be transmitted to an inference pipeline to create annotations on an image to identify one or more subject matters of interest. In the case of video input, sampling frequency may be used to configure an inferencing batch size to increase video inference efficiency. Sampling frequency may be optimized by monitoring inference and inferencing rejection rate by an annotator (e.g., low sampling rate for any batch may result in an inaccurate display of results). An annotation team may review inferencing results through random samples, and reannotate the images and detect if there is false positive and false negative. Then, after the reannotation, a new model for correction of wrong object feature of interest may be created (or an ML model may be updated) to run the inference for all images to inference the newness images. This annotation and reannotation process may repeat until an accuracy for the inferencing (e.g., for the annotation) exceeds an accuracy threshold. In some examples, a new ML module may be trained with correct data annotation using previous model(s) as initial weights.

In some examples, the ML training/inferencing may include minimal sample size for significance, where a minimal sample size is computed for a sample to guarantee that the sample has a similar result than the population (e.g., other samples) based on a margin of error. In other examples, the samples may be stratified based on the population distribution to avoid biased results. For examples, samples may be stratified or randomized based object feature, object, and/or region. Several batches of samples may also be created for the annotation team. Then, statistical information of N batches may be extracted and examined to pass a statistical test (e.g., a confidence interval-t-test). Partial results of the precision may be released and recall to the user using the batches images. In addition, performance results may be stored to monitor performance involvement over time. In another example, the ML training/inferencing may include offering small batch inferencing capability, which calculates whether the difference between batches is significantly different from zero or not. If not equal to zero, a batch may be discarded.

In another aspect of the present disclosure, the system for autonomous object inspection and object feature detection disclosed herein may be based on multi parallel processing using inference in video analytics. For example, FPS of videos may be modified to reduce the size of the videos to gain performance in video processing. In addition, multiple models may run in the images (e.g., photos and videos) analytics for optimization of processing in drones. Thus, there may be parallel processing for the ML inference and ML training for images, videos and acoustic.

The example implementations described herein may reduce SMEs' burden from the traditional labor-intensive, time-consuming examination process for detection of failure modes, objects, and object conditions, with a near real-time monitoring solution with minimal cost. For example, the example implementations may train an ML module to annotate subject matters of interest on an image via a semi-supervised manner, such that the ML module may be used for detecting and monitoring objects with minimal human intervention.

The example implementations may provide feasibility to build powerline, distribution line health tracking and failure alerting system based on the aspects described herein, with footprints about object conditions over time to predict remaining useful life, by leverage these metadata, a faster triage process can be provided to diagnose the right failure modes for different object component hierarchy.

The example implementations may provide analytics autonomous driven drone fleet schedule optimization with smart routing to maximize inspection area coverage at optimal frequency, focused information retrieving to zoom in on cases that require special attention or follow up monitoring.

The example implementations may provide a self-adapting and self-evolving model-based autonomous annotation program that may help alleviating resource intensive image annotation task for model retrain and model refinement.

The example implementations propose using sensor fusion to maximize information from different sensors to cross-examine the condition, or sequence triggering to build customized monitoring strategy by enable monitoring hierarchy to further minimize false positive and false negatives.

The example implementations may provide ad-hoc geographical failure pattern analysis, to identify the failure clusters to overlay with the internal (voltage, lifespan, materials, manufactures, production batch, etc.) and the external factors (weather, season, natural disaster, etc.) to understand incidence event causation, and to predict the next similar event in future.

The example implementations may provide enable the safety of the field team to be prioritized with the help of the consistent machine learning based methods for the object and object feature detections.

The example implementations may provide may improve the productivity of the inspection team by reducing the time spent in the field and increasing the number of objects that can be inspected.

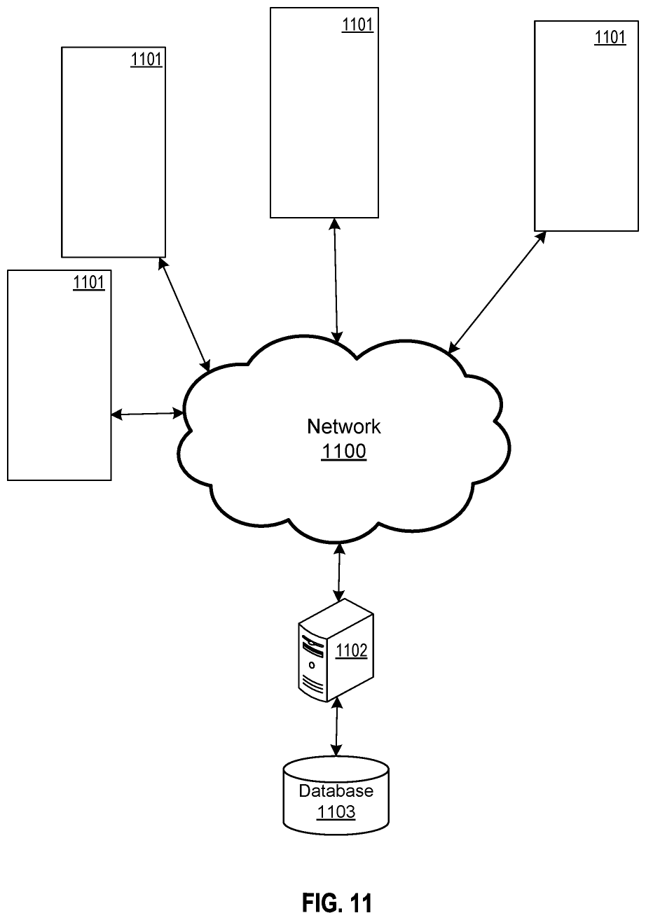

FIG. 11 illustrates a system involving a plurality of assets networked to a management apparatus, in accordance with an example implementation. One or more assets 1101 are communicatively coupled to a network 1100 (e.g., local area network (LAN), wide area network (WAN)) through the corresponding on-board computer or Internet of Things (IoT) device of the assets 1101, which is connected to an ML apparatus 1102. The ML apparatus 1102 manages a database 1103, which contains historical data collected from the assets 1101 and also facilitates remote control to each of the assets 1101. In alternate example implementations, the data from the assets can be stored to a central repository or central database such as proprietary databases that intake data, or systems such as enterprise resource planning systems, and the ML apparatus 1102 can access or retrieve the data from the central repository or central database. Asset 1101 may involve any image capturing devices, ML modules, and/or transportations for use in an ML process in accordance with the desired implementation, such as but not limited to drones/rovers with cameras and/or other types of sensors, and so on in accordance with the desired implementation. The images captured from image capturing devices of such assets 1101 may serve as the data flows or input as described herein upon which inference (e.g., annotation) may be conducted.

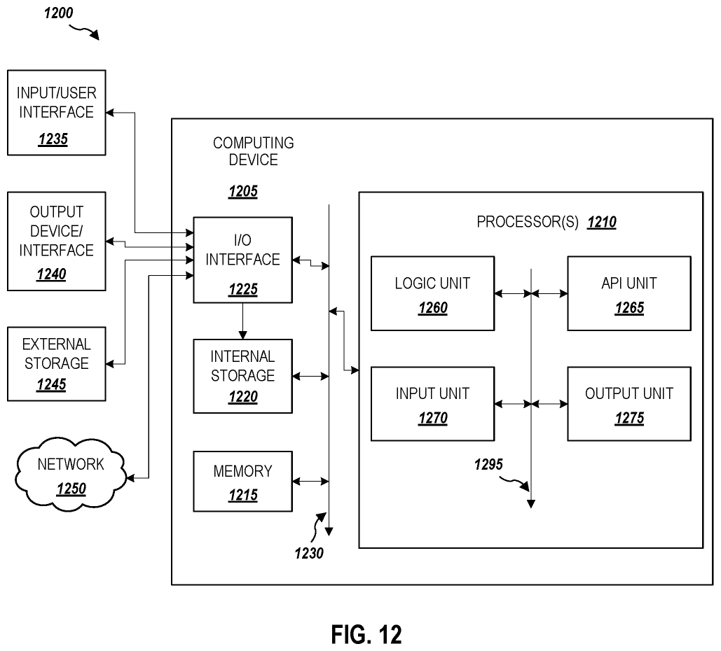

FIG. 12 illustrates an example computing environment with an example computer device suitable for use in some example implementations, such as an ML apparatus 1102 as illustrated in FIG. 11, or as an on-board computer of an asset 1101. The computing environment can be used to facilitate implementation of the architectures illustrated in FIGS. 1 to 10. Further, any of the example implementations described herein can be implemented based on the ML modules, image capturing device, ML inference/training host, and so on as illustrated in FIGS. 1 to 10. Computer device 1205 in computing environment 1200 can include one or more processing units, cores, or processors 1210, memory 1215 (e.g., RAM, ROM, and/or the like), internal storage 1220 (e.g., magnetic, optical, solid-state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

Processor(s) 1210 can be configured to execute instructions for a method of autonomous visual inspection, the instructions involving receiving images autonomously captured via at least one image capturing device; identifying at least one object from the images autonomously based on a set of inference data from an ML module; identifying at least one feature of the at least one object autonomously based on the set of inference data; and initiating an alert autonomously if the at least one feature meets a defined condition or a threshold as described, for example, in FIGS. 1 to 10.

Processor(s) 1210 can be configured to execute instructions for a method of autonomous visual inspection, the method involving deduplicating one or more images from the images captured via the at least one image capturing.

Processor(s) 1210 can be configured to execute instructions for a method of autonomous visual inspection, the method involving annotating the at least one object or the at least one feature identified on the images via the ML module; reviewing and reannotating one or more images from the images based on a set of inferenced images; and retraining the ML module based on the one or more images, as illustrated in FIGS. 1 to 4.

Processor(s) 1210 can be configured to execute instructions for a method of autonomous visual inspection, the method involving monitoring the at least one object or the at least one feature for a period of time as illustrated in FIGS. 1, 3, 5E.

Processor(s) 1210 can be configured to execute instructions for a method of autonomous visual inspection, the method involving applying a de-duplication process to the images to remove one or more images with a same image context, as illustrated in FIGS. 1 to 4.

Processor(s) 1210 can be configured to execute instructions for a method of autonomous visual inspection, the method involving training the ML module based on a previous classification or detection ML models using a transfer learning based approach, and based on a set of annotated images being approved to create the set of inference data, as illustrated in FIGS. 1 to 4.

Processor(s) 1210 can be configured to execute instructions for a method of autonomous visual inspection, the identifying the at least one object from the images autonomously based on the set of inference data further involves classifying the at least one object as an object of interest from a plurality of objects in the images based on the set of inference data, as illustrated in FIGS. 1 to 4 and 5A.

Processor(s) 1210 can be configured to execute instructions for a method of autonomous visual inspection, the identifying the at least one feature of the at least one object autonomously further involves generating an annotation for the at least one object for the at least one on the images autonomously based on the set of inference data; identifying whether the annotation for the at least one object is erroneous; and updating a set of training data based on the annotation for the at least one object being identified as erroneous for retraining the ML module, as illustrated in FIGS. 1 to 4.

Processor(s) 1210 can be configured to execute instructions for a method of autonomous visual inspection, the method involving receiving sensing information or surrounding information associated with the at least one object from at least one sensor; wherein the identifying of the at least one object, the identifying of the at least one feature on the at least one object, or determining whether the at least one feature meets the defined condition or the threshold is further based on the sensing information or the surrounding information, as illustrated in FIGS. 6 to 9.

Processor(s) 1210 can be configured to execute instructions for a method of autonomous visual inspection, the method involving calculating a severity level automatically for the at least one feature, wherein the at least one feature meets the defined condition or the threshold including a failure mode when the severity level exceeds a severity threshold, as illustrated in FIG. 5D.

Processor(s) 1210 can be configured to execute instructions for a method of autonomous visual inspection, the method involving recording a condition of the at least one object in a database; tracking the condition of the at least one object over a period of time; and updating the database based on the tracking, as described in connection with FIGS. 1 to 3.

Processor(s) 1210 can be configured to execute instructions for a method of autonomous visual inspection, the method involving capturing meter images via the at least one image capturing device; identifying a reading of the meter based on the meter images; recording the reading of the meter in a database; periodically tracking readings associated with the meter over a period of time; and updating the database based on the tracking, as described in connection with FIGS. 1 to 3.

In any of the example implementations described herein, the at least one feature includes a severity condition, a failure mode, a remaining useful life, or a combination thereof.

In any of the example implementations described herein, the at least one image capturing device is allocated on at least one drone that is configured to use a landmark-based anchor to determine a surveillance approach and route for capturing the images of the at least one object.

In any of the example implementations described herein, the at least one image capturing device is configured to verify a quality of the images captured for the at least one object and take additional images of the at least one object if the quality does not meet a quality threshold or a set of defined criteria.

In any of the example implementations described herein, the receiving of the images, training of the ML module, the identifying of the at least one object, and the initiating of the alert are executed on at least one environment including an on-premise environment, an off-premise environment, or a combination thereof. as illustrated in FIGS. 6 to 9.

In any of the example implementations described herein, the at least one image capturing device is allocated on at least one drone that is configured to identify at least a location of the at least one object based on a geographic information system (GIS). The detecting the one or more features of object on the at least one object autonomously or determining whether the one or more features of object meet the defined condition, or the threshold autonomously is further based on the location of the at least one object as illustrated in FIGS. 6 to 9. As illustrated in FIG. 7, the at least one image capturing device is allocated on at least one drone that is configured to use a landmark-based anchor to determine a surveillance approach and route for capturing the images of the at least one object.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method of autonomous visual inspection, comprising:
receiving images autonomously captured via at least one image capturing device;
identifying at least one object from the images autonomously based on a set of inference data from a machine learning (ML) module;
identifying at least one feature of the at least one object autonomously based on the set of inference data; and
initiating an alert autonomously if the at least one feature meets a defined condition or a threshold.

2. The method of claim 1, further comprising:
deduplicating one or more images from the images captured via the at least one image capturing device.

3. The method of claim 1, wherein the at least one feature includes a severity condition, a failure mode, a remaining useful life, or a combination thereof.

4. The method of claim 1, further comprising:
annotating the at least one object or the at least one feature identified on the images via the ML module;
reviewing and reannotating one or more images from the images based on a set of inferenced images; and
retraining the ML module based on the one or more images.

5. The method of claim 1, further comprising:
monitoring the at least one object or the at least one feature for a period of time.

6. The method of claim 1, wherein the at least one image capturing device is allocated on at least one drone that is configured to identify at least a location of the at least one object based on a geographic information system (GIS).

7. The method of claim 6, wherein the identifying of the at least one object or the identifying of the at least one feature on the at least one object is based on the location of the at least one object.

8. The method of claim 1, further comprising:
applying a de-duplication process to the images to remove one or more images with a same image context.

9. The method of claim 1, wherein the at least one image capturing device is allocated on at least one drone that is configured to use a landmark-based anchor to determine a surveillance approach and route for capturing the images of the at least one object.

10. The method of claim 1, wherein the at least one image capturing device is configured to verify a quality of the images captured for the at least one object and take additional images of the at least one object if the quality does not meet a quality threshold or a set of defined criteria.

11. The method of claim 1, further comprising:
training the ML module based on a previous classification or detection ML models using a transfer learning based approach, and based on a set of annotated images being approved to create the set of inference data.

12. The method of claim 1, wherein the identifying the at least one object from the images autonomously based on the set of inference data further comprises:
classifying the at least one object as an object of interest from a plurality of objects in the images based on the set of inference data.

13. The method of claim 1, wherein the identifying the at least one feature of the at least one object autonomously further comprises:
generating an annotation for the at least one object for the at least one on the images autonomously based on the set of inference data;
identifying whether the annotation for the at least one object is erroneous; and
updating a set of training data based on the annotation for the at least one object being identified as erroneous for retraining the ML module.

14. The method of claim 1, further comprising:
receiving sensing information or surrounding information associated with the at least one object from at least one sensor; wherein the identifying of the at least one object, the identifying of the at least one feature on the at least one object, or determining whether the at least one feature meets the defined condition or the threshold is further based on the sensing information or the surrounding information.

15. The method of claim 1, further comprising:
calculating a severity level automatically for the at least one feature, wherein the at least one feature meets the defined condition or the threshold including a failure mode when the severity level exceeds a severity threshold.

16. The method of claim 1, further comprising:
recording a condition of the at least one object in a database;
tracking the condition of the at least one object over a period of time; and
updating the database based on the tracking.

17. The method of claim 1, wherein if the at least one object is associated with a meter, the method further comprises:
capturing meter images via the at least one image capturing device;
identifying a reading of the meter based on the meter images;
recording the reading of the meter in a database;
periodically tracking readings associated with the meter over a period of time; and
updating the database based on the tracking.

18. The method of claim 1, wherein the receiving of the images, training of the ML module, the identifying of the at least one object, and the initiating of the alert are executed on at least one environment including an on-premise environment, an off-premise environment, or a combination thereof.

19. A computer program, storing instructions for autonomous visual inspection, the instructions comprising:
receiving images autonomously captured via at least one image capturing device;
identifying at least one object from the images autonomously based on a set of inference data from a machine learning (ML) module;
identifying at least one feature of the at least one object autonomously based on the set of inference data; and
initiating an alert autonomously if the at least one feature meets a defined condition or a threshold.

20. An apparatus for autonomous visual inspection, comprising:
a memory; and
at least one processor coupled to the memory and configured to:
receive images autonomously captured via at least one image capturing device;
identify at least one object from the images autonomously based on a set of inference data from a machine learning (ML) module;
identify at least one feature of the at least one object autonomously based on the set of inference data; and
initiate an alert autonomously if the at least one feature meets a defined condition or a threshold.
